(19) United States
(12) Patent Application Publication
(10) Pub. No.: US 2019/0383365 A1
(43) Pub. Date: Dec. 19, 2019

(54) LINKAGE FOR THE TRANSMISSION MECHANISMS

(71) Applicants: Cyril CLOPET, PIREY (FR); Pierre AZZOPARDI, BESANCON (FR)

(72) Inventors: Cyril CLOPET, PIREY (FR); Pierre AZZOPARDI, BESANCON (FR)

(21) Appl. No.: 16/464,748

(22) PCT Filed: Nov. 30, 2017
(86) PCT No.: PCT/FR2017/053323

§ 371 Date: May 29, 2019

(30) Foreign Application Priority Data
Dec. 1, 2016 (FR) 1661792

(51) Int. Cl. F16H 9/24; F16G 5/18; F16G 13/02

(52) U.S. Cl. CPC F16H 9/24; F16G 13/02; F16G 5/18

(57) ABSTRACT

Transmission linkage (2) for a continuously variable transmission mechanism (1) comprising at least one wheel (3, 4, 5) comprising two rotating flanges (31, 32, 41, 42, 51, 52), said linkage comprising: a first set of first links (210, 210′, 410, 410′, 510, 510′, 700, 800, 900) having bearing surfaces (2106, 2107, 2108, 2109) able to come into contact between two flanges; a second set of second links (212, 412, 512) hinged to one another to form a closed-loop chain, the number of second links being equal to the number of first links; according to the invention, each link of one of the sets comprises a meshing pin (2120, 2120′, 2120″, 4103, 505, 600, 632, 642) and each link of the other set comprises at least one closed reception housing (2110, 2110′ 415, 515, 615, 621, 631, 641, 651) comprising meshing walls (2111, 624) engaging with said meshing pin via a meshing connection, said meshing connection allowing each first link to move with respect to the second link with which it collaborates, at least in a longitudinal direction (L).

### TECHNICAL FIELD

The invention relates to the field of transmission mechanisms, particularly transmission mechanisms with a continuously variable reduction ratio. More particularly, the invention relates to a transmission link for such a mechanism.

### PRIOR ART

Patent FR 2 571 113 describes such a transmission link comprising two sets of chain links forming two distinct chains interacting with a pair of conical flanges, arranged in such a way that the first set of chain links comes into contact with the flanges and has a shape allowing a geared connection to be made with the second set.

The two chains are made in such a way that the first set has a greater length than that of the second set. Now, this feature implies that the two sets of chain links have separate trajectories, so that during the circulation of the chains there is at least one period during which the first set and the second set are not in contact. Such a loss of contact has several disadvantages:
First, the fact of having two distinct sets of chain links circulating, needs each set to be tensioned separately, which would prove to be difficult in a transmission with strict limits on available space;
Second, either of the two sets must have an opening allowing the engagement and disengagement connection to be achieved and said opening weakens the chain links concerned by imposing bending.

The invention aims to provide a transmission link for a continuously variable transmission mechanism, allowing faults with transmission links known in the prior art to be avoided.

### DESCRIPTION OF THE INVENTION

To this end, the invention relates to a transmission link, for a continuously variable transmission mechanism comprising at least one wheel comprising two flanges rotating about an axis of rotation, said link comprising:
A first flexible set of first chain links having bearing surfaces capable of coming into contact between two flanges of a wheel of said mechanism;
A second flexible set of second chain links mutually articulated to form a chain or a belt in a closed loop, the number of second chain links being equal to the number of first chain links, each of the said second chain links having a longitudinal direction tangential to the closed loop.
   According to the invention, each chain link of one of the sets comprises an engagement rod and each chain link of the other set comprises at least one closed receiving slot comprising engagement walls interacting with said engagement rod by a meshed connection, said meshed connection enabling a mobility of each first chain link in relation to the second chain link with which it interacts, at least along the longitudinal direction.

In the sense of the invention, a meshed connection is to be understood as when the chain links of the first set interact with the flanges of a pulley, the push of the engagement rods on the engagement walls generates a force along the longitudinal direction allowing the existing tension between two successive second chain links of the second set to decrease progressively within a driving winding and to increase progressively within a driven winding. Thus, the meshed connection existing between the receiving slot and the engagement rod reproduces on a variable diameter winding the meshed connection existing between a toothed pinion and a chain. Furthermore, when a first chain link no longer interacts with the flanges of a pulley, this meshed connection has the particular feature of allowing the said first chain link to be displaced along the longitudinal direction in relation to the second chain link with which it interacts with a very low force with regard to the tension that can be transmitted by the link. To effect this longitudinal displacement, it is not, for example, necessary to elastically deform the first or second chain link or to deform a spring whose deformation force is comparable to the tension transmissible by the link.

Moreover, each chain link of the first set is articulated with a single chain link of the second set. Such an articulation allows a solid and resistant transmission link because it does not have the disadvantage of known links of the prior art. Indeed, it is not necessary to have chain links with openings. Due to this fact, the chain links of the transmission link are not subject to weakening by bending.

Furthermore, for the two sets of chain links forming a single link, it is not necessary to tension each set of chain links separately from the other set of chain links.

Advantageously, each first chain link is separated by another adjacent first chain link by a first pitch P1 and each second chain link is separated from another adjacent second chain link by a second pitch P2, the first pitch P1 being approximately equal to the second pitch P2.

Thus, when several successive first chain links interact with the wheel and become temporarily integral with the same, they are separated by a pitch P1 and form a solid regular support with a pitch P1. As P1 is approximately equal to P2, several successive second chain links are capable of interacting by meshing with the said regular solid support with pitch P1 formed by the several successive first chain links.

Advantageously, the first chain links are in contact with each other along the longitudinal direction in the direction of the link movement, at least before interacting with the flanges of a wheel of the transmission mechanism, the first set comprising mutual pushing means

Due to this fact, as the mechanism functions, when the second set of chain links elongates due to the transmission of a tension between one driving wheel and one driven wheel, the mutual pushing means allows the first chain links to advance along the longitudinal direction in the direction of the link movement so as to compensate for this elongation of the second set of chain links. Thus, the solid support formed by the chain links of the first set when they are wound is not affected by the elongation of the chain links of the second set.

Advantageously, each chain link comprising a receiving slot is capable of pivoting about a pivot axis approximately parallel to the axial direction A and passing inside the receiving slot of at least one contiguous chain link, said pivot axis being a nominal position of said receiving slot of the contiguous chain link, which nominal position is a position that the axis of the engagement rod may occupy.

The fact that each receiving slot has a nominal position coincident with the pivot axis of a contiguous chain link comprising a receiving slot provides the advantage, when several receiving slots are located in a driving or driven winding, of maintaining the nominal positions of two successive receiving slots separated from a pitch P1 or P2 and also, when two successive engagement rods are located in the said nominal positions, thus the distance separating the axes of said two engagement rods is equal to P1 or P2. Judiciously, when the receiving slot is located in a winding and that its engagement walls are constructed in such a way that the trajectory described by the axis of the engagement rod when it runs across said engagement walls forms approximately a triangle having a bisector coming from an apex approximately equal to a radius, then the nominal position is chosen approximately coincident with said apex.

Advantageously, the engagement rod has an axis approximately parallel to the axial direction A and coincident with the pivoting axis of two successive chain links belonging to the set of chain links comprising said engagement rod

This provides the advantage, when the chain links comprising the engagement rod are no longer in a straight line but pivot to enter into a driving or driven winding, to keep a distance between 2 axes of two successive engagement rods equal to P1 or P2.

Advantageously, either of the sets of chain links comprises a temporary return means of the engagement rod towards the nominal position of the receiving slot.

In this case, the pitch P2 becomes equal to the pitch P1, and this thus constitutes an alternative means allowing the engagement rods to be positioned conveniently in relation to the receiving slots. The fact that this return means is temporary allows the engagement rod to be displaced freely inside the receiving slot when the said return means is no longer active.

Advantageously, each first chain link comprises at least one shape plate capable of being pushed on a shape plate of at least one other contiguous first chain link; one of the said contiguous first chain links in contact is said to be the reference first chain link, the other contiguous first chain link in contact is said to be the mobile first chain link, said mobile first chain link being capable of pivoting about a pivot axis of said reference first chain link along a trajectory that is approximately circular, the pivot axis of the mobile first chain link being separated from the pivot axis of the reference first chain link by a radius approximately equal to pitch P1.

This provides the advantage, in combination with the mutual pushing means that, when two successive first chain links are in mutual contact by means of their shape plate, a temporary articulation, non-holding in tension, is formed between said two successive chain links, said temporary articulation keeping the nominal positions of two successive receiving slots when they belong to the first chain links, or the axes of two successive engagement rods, when they belong to the first chain links, distant of a pitch P1.

Advantageously, the receiving slot belongs to a receiving solid integral with either of the sets of chain links or to a shape plate forming a receiving solid, said receiving solid being capable of pivoting at least about an axis parallel to the axial direction A and coincident with the nominal position of the receiving slot.

As the transmission link of the present invention is to function with driving or driven windings with variable radius, this has the advantage of enabling the engagement walls of the receiving slot to be oriented in relation to a radius passing through the nominal position.

Advantageously, the receiving solid, or the shape plate forming a receiving solid, has at least one orientation means capable of orienting the receiving slot.

In combination with the freedom of rotation of the receiving solid, the orientation means provides the advantage of orienting the receiving solid in such a way that the engagement walls of the receiving slot are approximately symmetrical in relation to a radius passing through the nominal position, in spite of the change of inclination between two successive chain links due to a change of the winding radius, for example.

Advantageously, the whole bearing surfaces of a first chain link in contact on each flange of a wheel has a contact barycentre and advantageously, said contact barycentres on both sides of said first chain link are joined by a straight line passing inside the receiving slot.

Thus, when the engagement rod pushes on an engagement wall of the receiving slot, the force provided by said engagement rod is approximately coincident with the straight line joining the barycentres of the bearing surfaces of the first chain link on the flanges on both sides of the link. This provides the advantage of minimising or even cancelling the rotation torque that applies on the first chain link due to the push of the engagement rod on the engagement wall of the slot, and improves the stability of the contact of the first chain link on the flanges of the wheel. Judiciously, the said straight line joining the barycentres of the bearing surfaces of the first chain link on the flanges of the wheel may pass through the geometric centre of the receiving slot or through the nominal position.

Advantageously, the receiving slot has a general shape that is approximately triangular.

This triangular shape has three walls, two engagement walls which interact with the engagement rod, and a closing wall, which does not interact with the engagement rod in the driving or driven winding. The fact that the engagement walls are two in number and are approximately arranged in a “V” shape allows the engagement rod always to interact with an engagement wall, even if the direction of the tension reverses, in other words, if the driving winding becomes driven, for example. In this, the receiving slot and the engagement rod reproduce, on a variable diameter winding, the prior art known behaviour of pinion-chain pairs on a fixed diameter winding.

According to a feature of the invention, each chain link of the first set is made up of one or several receiving solids having receiving slots which nominal positions are aligned along an axial direction parallel to the axis of the wheel, said receiving solids are fixed mutually rigidly and have compression rigid beams extending in the axial direction above and below the closed loop formed by the chain links of the second set, and which are capable of coming into contact with the flanges of a wheel on both sides of the link.

According to a feature of the invention, the shape plates of the first chain links comprise at least one portion of a circle of diameter P1, concentric with the nominal position of the receiving slot or slots.

According to a feature of the invention, the second set of chain links is a transmission chain, of which each second chain link is made up of one or more plates of pitch P2 interconnected by an articulation pivot, which articulation pivot is integral with an engagement rod extending into the receiving slot or slots of a chain link of the first set.

According to a feature of the invention, the temporary return means of the engagement rod towards the nominal position of the receiving slot is a latch being capable of being interposed between a first and a second chain link, said latch being able to be actuated by a cam integral with the supporting frame.

According to a feature of the invention, the receiving solid is approximately cylindrical and its axis coincides with the nominal position of the receiving slot, said receiving slot crossing the receiving solid from side to side.

According to a feature of the invention, the second set of chain links is a transmission chain made up of a succession of connecting plates, from which the articulation pivots are cylindrical receiving solids.

According to a feature of the invention, each chain link of the first set comprises an engagement rod rigid in compression along an axial direction, said engagement rod extending through the receiving slot of an approximately cylindrical receiving solid, and being capable of coming into contact with the flanges of a wheel on both sides of the link by means of soles, said engagement rod being fixed rigidly to at least one shape plate comprising a circular portion with diameter P1, said circular portion being approximately concentric with the axis of said engagement rod.

According to a feature of the invention, each engagement rod comprises at least two shape plates on both sides of the link, said two shape plates comprising soles in contact with the flanges of a wheel.

According to a feature of the invention, the engagement rod comprises, at the location where it interacts with the receiving slot, a roller coming into contact with the receiving slot. This technique and the advantages that it provides are well known from the prior art of transmission roller chains whose axes are equipped with rollers coming into contact with the teeth of sprockets, said rollers roll on the teeth of the sprockets and slide on the articulation axes. In the case of large scale transmissions, it is possible to replace the roller with a bushing on a bearing so that it rolls on the axis of the engagement rod.

According to a feature of the invention, so as to limit the internal friction of the articulations of the chain links of the second set, the second chain links may be mutually articulated by a rolling connection, in other words, either by a rolling bearing separating the pivoting axis and at least one set of plates or by making the plates mutually articulated by pins rolling on each other as in well known prior art of so called silent chains.

According to a feature of the invention, the transmission link may be used with one or more wheels comprising gripping means operating by jamming of a blocking element.

According to a feature of the invention, the chain links of the second set may form a belt comprising either:
receiving slots and in this case the receiving slots will have their nominal positions along the neutral axis of the belt and the gap between two nominal positions of two successive receiving slots will be equal to P2,
or engagement rods and in this case the axes of the engagement rods will be positioned along the neutral axis of the belt and the gap between the axes of two successive engagement rods will be equal to P2.

According to a feature of the invention, in the case where the transmission of a force between a wheel of the mechanism and the transmission link is achieved by gripping means integral with the link functioning by jamming of a blocking element, the chain links of the first set may comprise at least one support surface on each side of the link, each intended to receive a blocking element capable of interacting with a flange of a wheel of the mechanism. In this case, the shape plates by which two successive chain links of the first set are in contact with each other may be achieved directly on the blocking element. Moreover, said blocking element may act on a latch forming a temporary return means for the engagement rod towards the nominal position.

The features described above relate to preferred embodiments, they may be taken in combination or separately.

### BRIEF DESCRIPTION OF THE FIGURES

Other features and/or advantages will appear on reading the following description of a preferred embodiment, given as non-limiting example, in relation to the attached drawings, in which:

FIGS. 1 and 2 show two general views of a transmission mechanism comprising a transmission link according to a first embodiment of the invention;

FIGS. 3 to 9 show views of a set of chain links of the transmission link of FIGS. 1 and 2;

FIG. 10 is a variant of the embodiments of FIGS. 1 to 9;

FIGS. 11 to 14 show a second embodiment of the link according to the present invention;

FIGS. 15 to 18 show variants of the embodiments of FIGS. 1 to 9 having first chain links interacting with the wheels of the mechanism by means of a blocking element;

FIGS. 19 to 21 show variants of the embodiments of FIGS. 1 to 9 having various means of orientation;

FIG. 22 shows a variant of the embodiment of FIGS. 11 to 14;

FIG. 23 to FIG. 24 show variants of the embodiment of FIGS. 1 to 9 in which the engagement rod has a different shape;

FIG. 25 is another embodiment in which each of the first chain links comprises a set of parallel receiving solids;

FIG. 26 shows examples of possible shapes of the receiving slot.

FIGS. 27 to 30 show an embodiment in which each first chain link comprises a temporary return means of the engagement rod towards the nominal position of the receiving slot.

### DETAILED DESCRIPTION

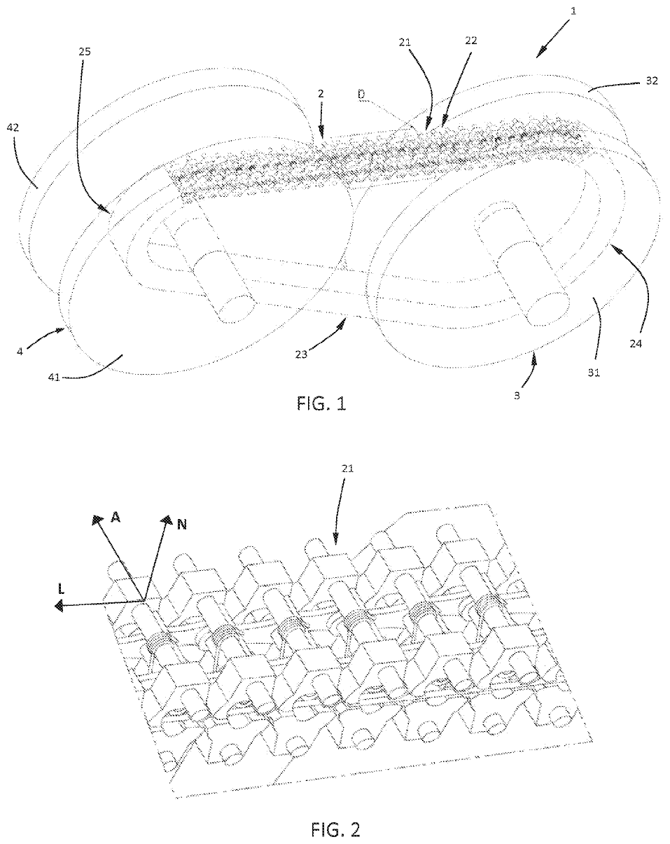

FIG. 1 shows a general view of a continuously variable transmission mechanism 1 comprising an example of a transmission link 2 according to the invention. In this example, the transmission link 2 is a chain comprising a set of chain links 21. In other embodiments as in FIG. 10, the link 2 may comprise a belt.

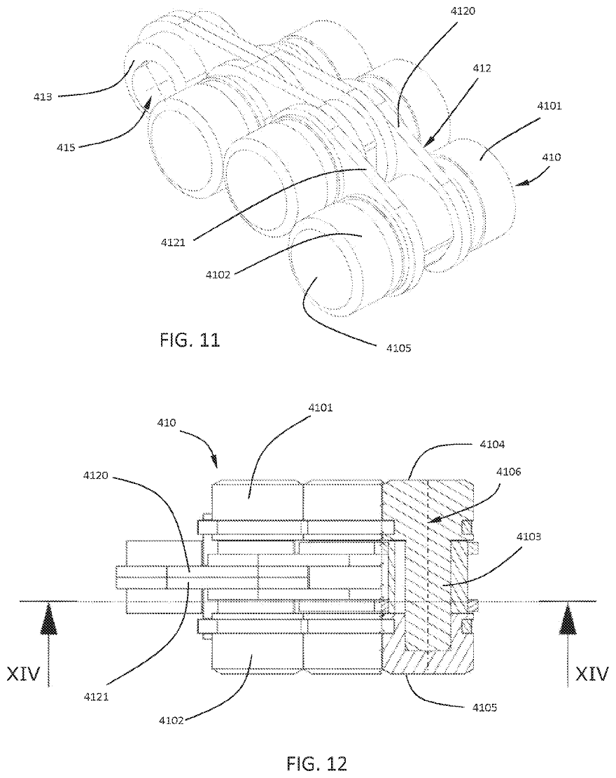

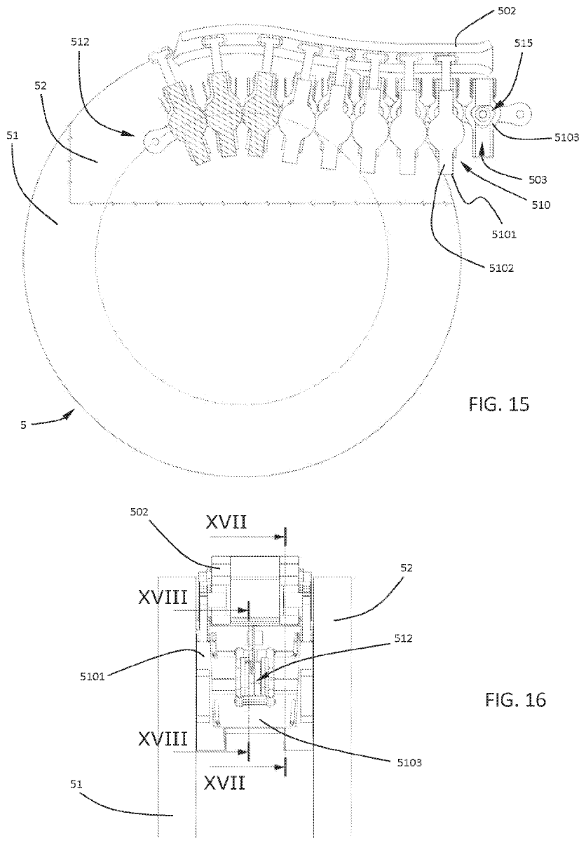

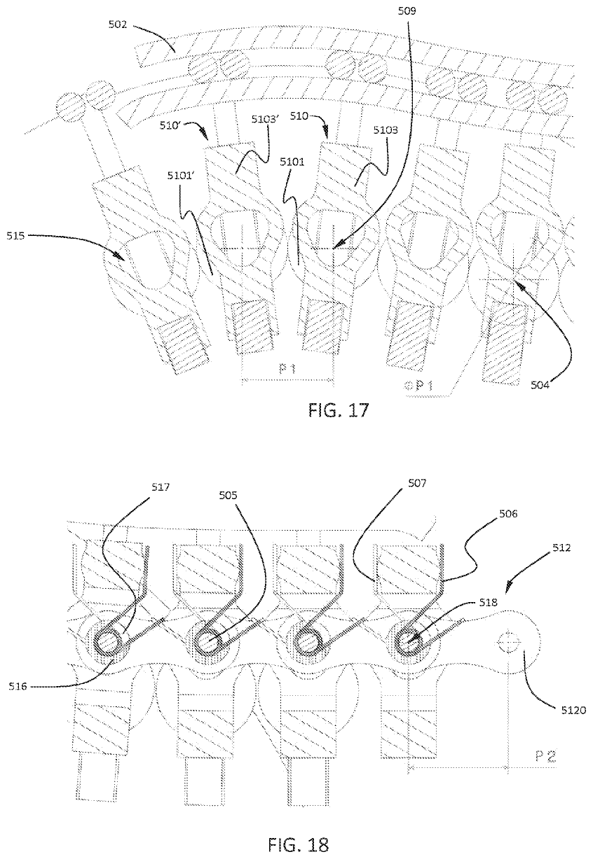

The link 2 forms a closed loop interacting with two wheels 3, 4 each comprising two conical flanges 31, 32, 41, 42. Its trajectory defines a tensioned strand 22 and a loose strand 23, as well as two winding portions 24, 25 which correspond to angular portions of the wheels around which the link is wound. In other embodiments, as for example in FIGS. 11 to 14, the wheels may comprise flanges comprising gripping means functioning by jamming a blocking element. In other embodiments, as in FIGS. 15 to 18, the wheels may comprise plane flanges.

FIG. 2 is an enlarged view of detail D, showing the chain links 21 forming the transmission chain according to this first embodiment. The arrows L, A, N respectively show the longitudinal direction L, which corresponds to the direction tangent to the transmission link; the axial direction A, which corresponds to any direction parallel to the axes of rotation of the wheels 3, 4; and the normal direction N, which corresponds to the perpendicular direction to the longitudinal direction L and the axial direction A.

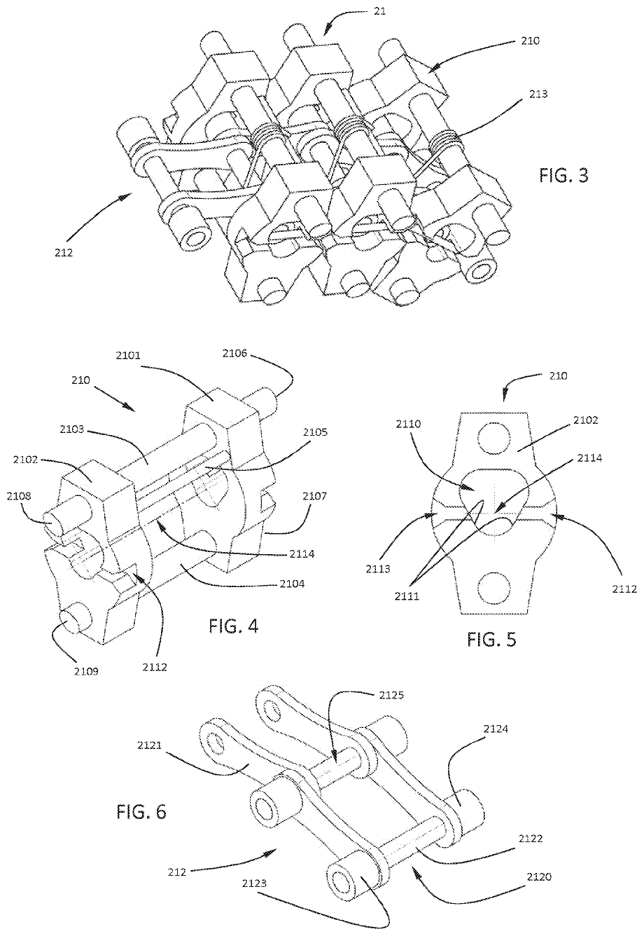

FIG. 3 shows an isometric view of a set of chain links 21 comprising the first chain links 210 and the second chain links 212. The second chain links 212 are mutually articulated to form a closed loop. In this embodiment, the first successive chain links 210 are not mutually articulated but come into mutual contact by means of springs 213 supported by the second chain links 212 and pushing the first chain links 210. The springs 213 thus constitute the mutual pushing means of the first chain links 210.

FIG. 4 and FIG. 5 show a first chain link 210, respectively according to an isometric view and according to a side view. The first chain link 210 comprises two side plates which are also the shape plates 2101, 2102. The two shape plates are interconnected by two spindles 2103, 2104, each of which terminates on each side by a bearing surface 2106, 2107, 2108, 2109 protrusive with regard to the shape plate 2101, 2102. The bearing surfaces 2106, 2107, 2108, 2109 are intended to engage flanges 31, 32, 41, 42 of wheels 3, 4 when the first chain link is located in a winding portion 24,25.

Furthermore, the first chain link 210 comprises a third spindle which is a supporting spindle 2105 serving as a spring support 213 (not shown on this figure).

Each of the shape plates 2101, 2102 comprises a receiving slot 2110 which comprises engagement walls 2111. In this embodiment, the receiving slot 2110 has an approximately triangular shape and the engagement walls 2111 form a “V”.

In this embodiment, the shape plates 2101, 2102 themselves form receiving solids, as each of them comprises a receiving slot 2110. In other embodiments, the receiving slot may belong to a receiving solid different from a shape plate.

Furthermore, each shape plate 2101, 2102, comprises two grooves 2112, 2113 used for the passage of an orientation means. Each shape plate 2101, 2102 has a partially cylindrical shape, intended to be pushed on the partially cylindrical shape of a shape plate 2101, 2102 of a first contiguous chain link 210. Said partially cylindrical shape has an axis which is also a pivoting axis 2114 of a first contiguous chain link 210. The pivoting axis 2114 is approximately parallel to the axial direction A and passes inside the receiving slot 2110 in a nominal position of said receiving slot 2110. Furthermore, the whole bearing surfaces 2108, 2109 of the first chain link 210 on the flange 31, 41 has a barycentre and the whole bearing surfaces 2106, 2107 of the first chain link 210 on the flange 32, 42 also has a barycentre, which barycentres are joined by a straight line approximately merged with the pivoting axis 2114. Due to this partially cylindrical shape, the shape plates 2101, 2102 are capable of pivoting on themselves in rotation about the pivoting axis 2114. These shape plates 2101, 2102 thus constitute a receiving solid mounted as to rotate freely about a pivoting axis 2114 approximately merged with a nominal position of the receiving slot 2110.

FIG. 6 shows two second chain links 212 according to the embodiment of FIG. 3. Each chain link comprises an engagement rod 2120 and two connecting plates 2121. In this embodiment, each engagement rod 2120 is cylindrical and formed of a central part 2122 and two peripheral parts 2123, 2124 thicker than the central part 2122. Furthermore, the axis of the engagement rod 2120 is merged with a pivot axis 2125 of two successive second chain links 212. This pivot axis 2125 is approximately parallel to the axial direction A. Due to its cylindrical shape, when the engagement rod 2120 runs across the walls of the receiving slot 2110, the trajectory taken by the axis of the engagement rod 2120 approximately forms a triangle from which one of the apexes is merged with the pivoting axis 2114 which is a nominal position of the receiving slot 2110.

In other embodiments, the engagement rod may have a different shape.

When the transmission chain is assembled, the number of second chain links being equal to the number of first chain links, each first chain link interacts with a second chain link by a geared connection. Each engagement rod 2120 is inserted into the receiving slot 2110 of a first chain link 210.

When the link 2 is moving and transmits tension forces, the second chain links 212 elongate under the effect of tension and wear and the pitch P2 may thus increase without changing of the pitch P1. The engagement rod 2120 moves in the receiving slot 2110 along the longitudinal direction L to maintain a geared connection with the receiving slot 2110 in spite of the differences that are created between P2 and P1.

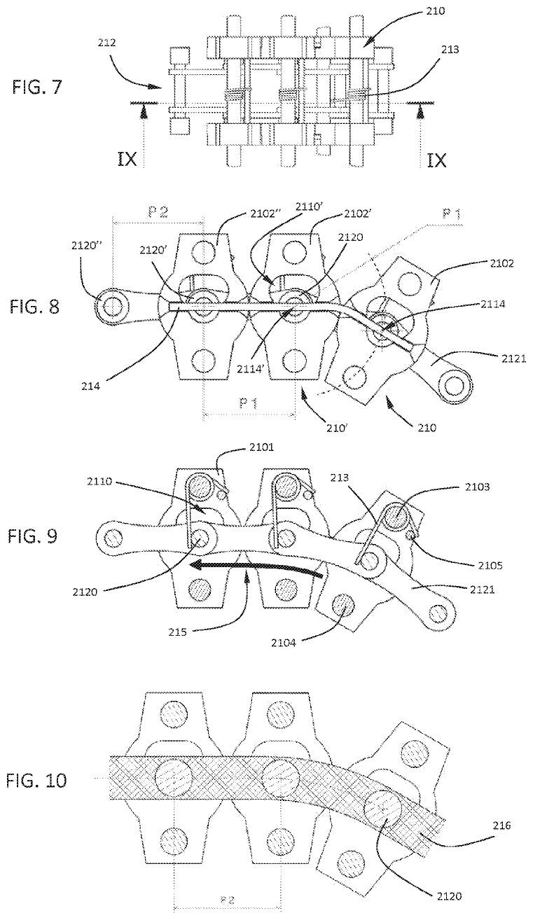

FIG. 7 shows a plan view of the set of chain links shown in FIG. 3.

FIG. 8 is a front view of the set of FIG. 7 on which an orientation means, for example, an orientation cable 214 passes through the grooves 2112, 2113 of each shape plate 2102. Furthermore, the engagement rods 2120, 2120′ are in their nominal position. Due to this orientation means, the receiving solids formed by the shape plates 2101, 2102 are angularly oriented in relation to the pivoting axis 2114. This orientation cable 214, for example, allows the engagement walls 2111 of the receiving slot 2110 to be approximately symmetrical in relation to the normal direction N passing by the chain link 21.

A pitch P1 separates each shape plate 2102′ from a first chain link of a contiguous shape plate 2102″ and each engagement rod 2120′ is separated from a neighbouring engagement rod 2120″ by a pitch P2. In this embodiment, P1 is equal to P2.

Furthermore, the trajectory of a pivoting axis 2114 of a first chain link 210 in relation to a pivoting axis 2114′ of another contiguous first chain link 210′ follows a circular arc of radius approximately equal to pitch P1. The pivoting axis 2114′ of the first chain link 210 mobile around the first reference chain link 210′ is situated inside the receiving slot 2110′ and this pivoting axis 2114′ is therefore a nominal position of the receiving slot 2110′.

FIG. 9 shows a longitudinal cross-sectional view along the plane IX-IX of FIG. 7. This figure illustrates the connection of engagement rods 2120 mutually forming the second chain links with the connecting plates 2121 and the connection of engagement rods 2120 with receiving slots 2110 of the shape plates 2101. So, as is shown, the springs 213 are fitted in opening between the engagement rod 2120, the spindle 2103 and the supporting spindle 2105 in such a way that, being supported by the engagement rods 2120, the springs 213 push the first chain links 210 with regard to the engagement rods 2120 in the direction of movement of the link indicated by the arrow 215.

FIG. 10 shows a variant embodiment which only differs from the example shown in FIG. 9 by the fact that the engagement rods 2120 of the second chain link are not mutually connected by connecting plates, but by a belt 216. In other terms, in this embodiment, the engagement rods 2120 are inserted through the belt 216 and the distance separating the axes of two successive engagement rods 2120 is approximately equal to P2. The axis of the engagement rods 2120 approximately coincides with a neutral axis of the belt 216. For the purpose of clarity, the mutual pushing means of first chain links with each other and the orientation means of receiving solids have not been represented in this FIG. 10.

FIGS. 11 and 12 represent respectively an isometric view and a plan view of a set of successive chain links according to a second embodiment of the invention. For reasons of clarity, flanges have not been shown in these FIGS. 11 to 14. These flanges may, for example, comprise gripping means functioning by jamming a blocking element.

In this example, the first chain links 410 are cylindrical rods each having two peripheral parts 4101, 4102 thicker than a central part 4103 forming an engagement rod. Furthermore, the peripheral parts 4101 and 4102 are cylindrical with diameters P1 and are also shape plates.

Each second chain link 412 is formed by a set of parallel connecting plates 4120, 4121 each comprising two bores of centre distance P2, and by a receiving solid 413 in the shape of a partially cylindrical bushing. The receiving solid 413 comprises a receiving slot 415 shaped approximately triangular which engagement walls form an inverse “V”.

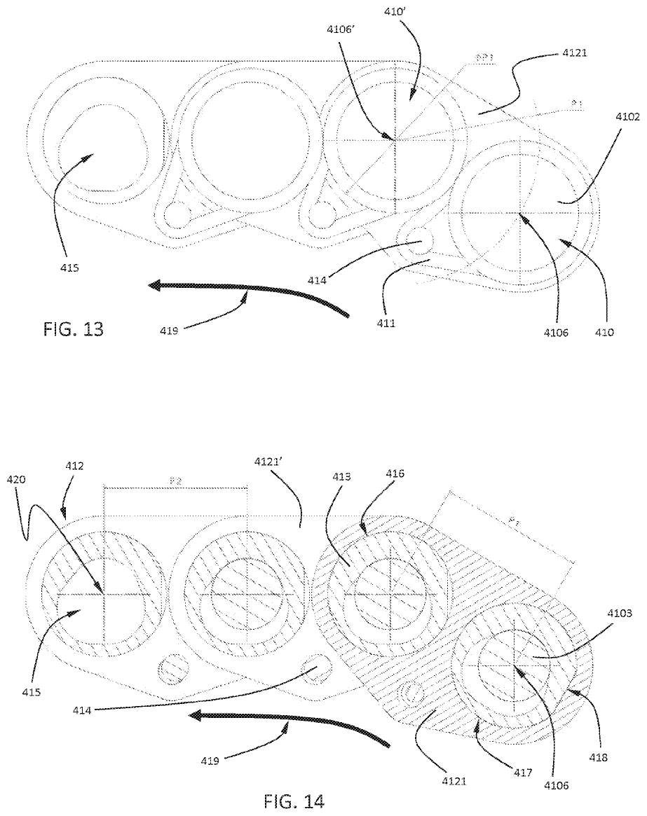

FIG. 13 shows a front view of the set of FIG. 11. Each first chain link 410 comprises two elastic bands 411, one of which is shown in FIG. 13. Each elastic band 411 is wound around a peripheral part 4101, 4102 and around a support spindle 414 taken into the connecting plates 4120, 4121. When coming into contact with the supporting spindles 414, these elastic bands 411 pull the first chain links 410 in the direction of movement of the link indicated by the arrow 419. The elastic bands 411 thus constitute a mutual pushing means of the first chain links 410.

FIG. 14 is a longitudinal cross-sectional view along the plane XIV-XIV of FIG. 12. As can be seen in this figure, the axes of two engagement rods formed by two central parts 4103 of two successive first chain links 410 are separated by a pitch P1 and the pivoting axes 420 of two successive second chain links 412 are approximately parallel to the axial direction A and are separated by a pitch P2. The pivoting axis 420 of two successive second chain links 412 is approximately parallel to the axial direction A and passes inside the receiving slot 415 and is a nominal position of said receiving slot 415. Furthermore, when the engagement rod formed by the central part 4103 runs across the walls of the receiving slot 415, the axis of said engagement rod has a triangular trajectory from which one of the apexes is merged with the nominal position of the receiving slot 415.

Moreover, the trajectory of a pivoting axis 4106 of a first chain link 410 in relation to a pivoting axis 4106′ of another contiguous first chain link 410′ is along a circle of radius equal to the first pitch P1, as FIG. 13 shows it. The axis of the engagement rod which is also the axis of a central part 4103 is thus a pivoting axis 4106 of at least one contiguous first chain link 410.

For two successive connecting plates 4121, 4121′, the first connecting plate 4121 in the direction of movement of the link indicated by the arrow 419 is called the upstream plate, the second connecting plate 4121′ in the direction of movement of the link 419 is called the downstream plate.

So as to orient the receiving solid 413, the latter is fitted non-pivoting in the downstream plate 4121′ and pivoting in the upstream plate 4121. Indeed, as FIG. 14 shows it, each connecting plate 4120, 4121 comprises a first cylindrical bore 416 allowing free pivoting in rotation in relation to the receiving solid 413. Each connecting plate 4120, 4121 also comprises a second bore 417 comprising a flat 418 allowing the receiving solid 413 to be fastened in rotation in relation to the plate.

Moreover, in this embodiment, the peripheral parts 4101, 4102 may also be used as supporting soles in contact on the flanges 31, 32, 41, 42 by the bearing surfaces 4104, 4105. In this case, the barycentres of each bearing surface 4104, 4105 on each flange of the wheel are joined by a straight line approximately merged with the axis of the engagement rod formed by a central part 4103 that passes inside the receiving slot 415.

A third embodiment is shown in FIGS. 15 to 18. FIG. 15 is a cut-away view of the wheel 5 and of a transmission link, in which each first chain link 510 interacts with each flange 51, 52 of the wheel 5 by means of a blocking element 5101 mobile along a guiding surface 503 belonging to the receiving solid 5103. In this case, the blocking element 5101 also forms a shape plate intended to be pushed on the contiguous blocking elements 5101, and each blocking element 5101 comprises a bearing surface 5102 coming into contact with flanges 51, 52.

FIG. 16 is a side view of the link of FIG. 15 and FIGS. 17 and 18 show respectively the cross-sections along the planes XVII-XVII and XVIII-XVIII of FIG. 16.

The orientation of the receiving slot 515 may be given by an orientation of the blocking element 5101 which is, for example, oriented by an orientation and actuation cam 502 articulated in relation to the supporting structure not represented. This orientation and actuation cam 502 thus constitutes an orientation means of the receiving slot 515.

So as to allow a variation of the winding radius of the transmission chain formed by such chain links, on the wheel, the orientation and actuation cam 502 may be fitted on a variation actuator, also not shown in the figures.

The blocking element 5101 moves on a guiding surface 503. Through its displacement, it reaches a coincidence position in which the pivoting axis 504, defined by the blocking element 5101 forming a shape plate comprising a circular portion with diameter P1, is merged with the nominal position 509 of the receiving slot 515. When two first contiguous chain links 510, 510′ have their blocking element 5101, 5101′ in a coincidence position and in mutual contact, then the respective nominal positions of receiving solids 5103, 5103′ are separated by a distance P1. The pivoting axis 504 is approximately parallel to the axial direction A.

Furthermore, so as to ensure the mutual contact of the first chain links 510, whatever the direction of circulation of the transmission link, the first chain links 510 may each be equipped with two springs 506, 507 shown in FIG. 18. These springs 506, 507 are guided on an engagement rod 505. They are in contact with the connecting plates 5120 of two chain links 512 and each pushes in an opposite direction. Furthermore, so as to limit the travel of the two springs 506, 507, they may be contained in two open hubs 516, 517 constituting a stop. When, due to the action of the orientation and actuation cam 502, the first chain links 510 are oriented, they push on one of the springs 506, 507, the other spring 506, 507 being inactive due to its stop on its open hub 516, 517. This push thus causes a forward movement of the first chain link 510 under the effect of its orientation. The mutual pushing means of the first chain links is therefore constituted by the springs 506, 507. The springs 506, 507 are also capable of being orientation means of the first chain link 510, when the latter does not interact with the orientation and actuation cam 502.

The engagement rods 505 are interconnected by connecting plates 5120 with a centre distance P2 and the axis of the engagement rods 505 is thus merged with a pivoting axis 518 of two successive second chain links 512, which pivoting axis 518 is approximately parallel to the axial direction A.

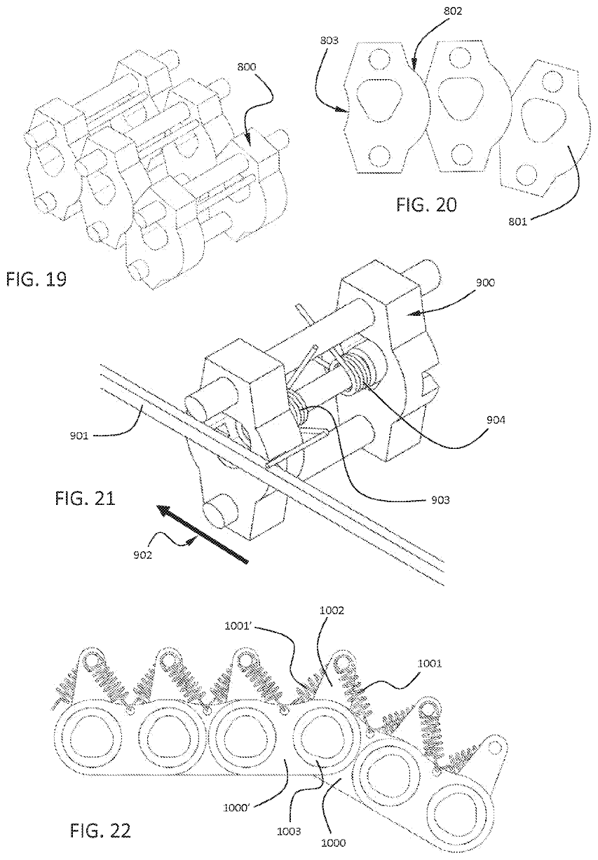

FIGS. 19 to 30 are schematic and show embodiments of first and/or second chain links or further of receiving slots, of shape plates, orientation and mutual pushing means or further of temporary return means of the engagement rod toward the nominal position of the receiving slot. For the purposes of clarity, FIGS. 19 to 30 do not comprise all the elements of the present invention, which elements may, for example, be taken from other embodiments.

FIGS. 19 and 20 respectively show an isometric view and a front view of another embodiment in which the first chain links 800 have a shape close to that of the first chain links of the embodiment represented by FIGS. 3 to 9. Nevertheless, in this embodiment, there is no orientation cable. As can be seen in FIG. 20, each shape plate 801 comprises a convex side 802 and a concave side 803. Each shape plate may pivot in relation to the plate with which it is contiguous.

FIG. 21 shows an embodiment similar to the example of FIG. 3 to FIG. 9, but in which the first chain link 900 is provided with two springs 903, 904 pushing simultaneously on a supporting cam 901 and on the first chain link 900, the spring 903 pushing the first chain link 900 in the direction indicated by the arrow 902 and the spring 904 pushing the first chain link 900 in the opposite direction to that indicated by the arrow 902. When the supporting cam 901 is retracted in front of either of the two springs 903, 904, this stops pushing the first chain link 900. The supporting cam 901 and the springs 903, 904 constitute a mutual pushing means for the first chain links 900.

FIG. 22 shows an embodiment similar to the examples of FIGS. 11 to 14, but in which each receiving solid 1003 is fitted as to rotate freely in the connecting plates 1000, 1000′ and is rigidly fastened to an orientation pin 1002 connected to the connecting plates 1000, 1000′ by two approximately identical orientation springs 1001, 1001′ which orient the orientation pin 1002 along the bisector of the angle formed by the connecting plates 1000, 1000′. The orientation springs 1001, 1001′ thus constitute an orientation means of the receiving slot.

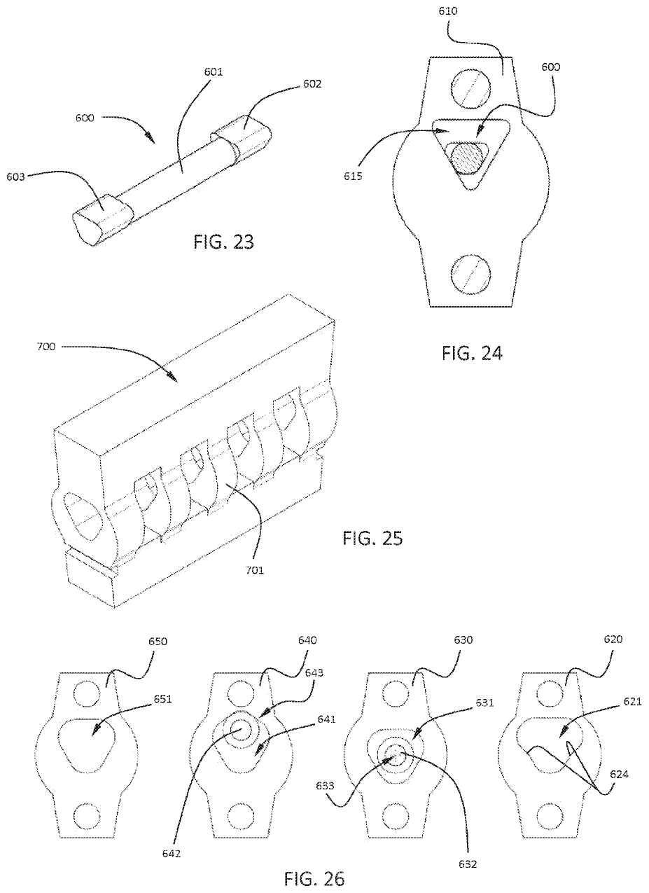

FIG. 23 represents an embodiment in which the engagement rod 600 has a cylindrical central part 601 and two peripheral parts 602, 603 with an approximately triangular cross-section.

FIG. 24 shows an embodiment in which the engagement rod 600 of FIG. 23 is used to provide a low pressure contact. The shape plate 610 of the first chain link is a receiving solid having a receiving slot 615 capable of interacting with said engagement rod 600.

FIG. 25 shows a schematic view of another embodiment in which each first chain link 700 is formed by a set of rigidly interconnected, parallel receiving solids 701. Such first chain links are, for example, usable to transmit powerful forces.

FIG. 26 shows examples of receiving solids 620, 630, 640, 650 that have receiving slots 621, 631, 641, 651 according to the invention of various shapes which may be used alone or in combination.

The receiving slot 651 is similar to that shown in FIGS. 3 to 9, while the receiving slot 641 has on its upper wall, which is a closing wall, a release enabling a greater freedom of movement of the engagement rod 642 inside the receiving slot 641. The receiving solid 630 is also a shape plate having a pivoting axis 633 such that when the engagement rod 632 has its axis merged with the pivoting axis 633, said engagement rod does not interact with the engagement walls of the receiving slot. This has the effect of shifting the primitive winding radii of the receiving slots 631 and of the engagement rods 632 and allows to have a better thickness of material around the receiving slot 631.

The receiving slot 621 has engagement walls 624 of non-planar shape, these engagement walls 624 may, for example, be formed by circular involutes or circular arcs. This particular feature has the effect of changing the force that the engagement rod exerts on the receiving solid 620 depending on the location of the engagement wall 624 with which said engagement rod interacts.

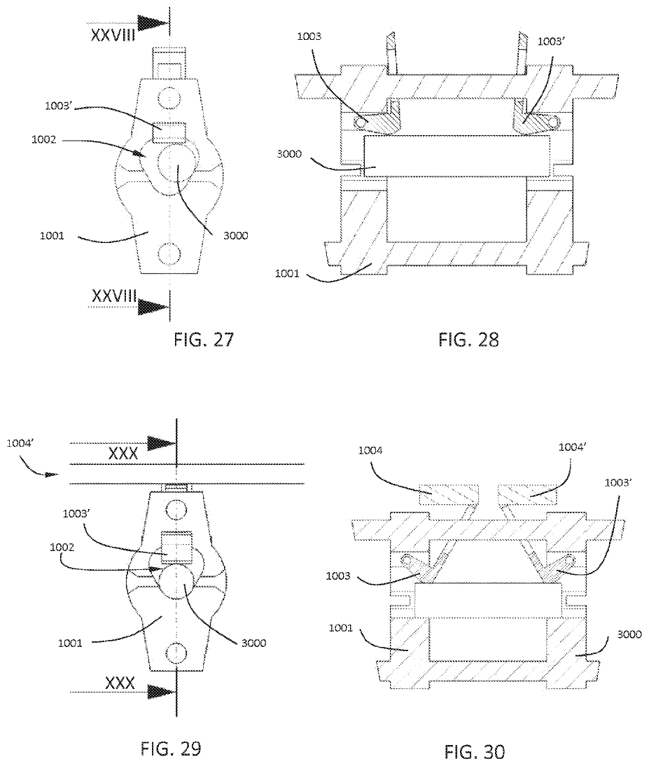

FIGS. 27 to 30 show an embodiment in which a chain link of the first set 1001 comprises a receiving slot 1002 and a latch fitted so that it pivots in relation to the first chain link and forming a temporary return means of the engagement rod to the nominal position 1003, 1003′.

FIGS. 27 and 28 are respectively a front view and a cross-section view along the axis XXVIII of said first chain link 1001 having the temporary return means of the engagement rod towards the nominal position 1003, 1003′ in an inactive position, the engagement rod 3000 being free to move inside the receiving slot 1002.

FIGS. 29 and 30 are respectively a front view and a cross-sectional view along the axis XXX of said first chain link 1001 having the temporary return means of the engagement rod towards the nominal position 1003, 1003′ in active position, said temporary return means of the engagement rod towards the nominal position 1003, 1003′ interacting with a cam 1004, 1004′ integral with the supporting frame by forcing said engagement rod 3000 to occupy the nominal position of the receiving slot 1002.

In a variant, when the chain link of the first set comprises a first bearing surface capable of accommodating a blocking element, the said blocking element may be connected to the temporary return means of the engagement rod in such a way that the displacement of said blocking element is capable of engaging or disengaging the temporary return means of the engagement rod towards the nominal position.

1. Transmission link (2) for a continuously variable transmission mechanism (1) comprising at least one wheel (3, 4, 5) comprising two flanges (31, 32, 41, 42, 51, 52) rotating about an axis of rotation, said link comprising:
A first flexible set of first chain links (210, 210′, 410, 410′, 510, 510′, 700, 800, 900) having bearing surfaces (2106, 2107, 2108, 2109, 4104, 4105, 5102) capable of coming into contact between two flanges of a wheel of said mechanism;
A second flexible set of second chain links (212, 412, 512) mutually articulated to form a chain or a belt (216) in a closed loop, the number of second chain links being equal to the number of first chain links, each of the said second chain links having a longitudinal direction (L) tangential to the closed loop;
Characterised in that each chain link of one of the sets comprises an engagement rod (2120, 2120′, 2120″, 4103, 505, 600, 632, 642) and each chain link of the other set comprises at least one closed receiving slot (2110, 2110′, 415, 515, 615, 621, 631, 641, 651) comprising engagement walls (2111, 624) interacting with said engagement rod by a meshed connection, said meshed connection enabling a mobility of each first chain link in relation to the second chain link with which it interacts, at least along the longitudinal direction.

2. Transmission link (2) according to claim 1, characterised in that each first chain link (210, 210′, 410, 410′, 510, 510′, 700, 800, 900) is separated from another adjacent first chain link by a first pitch P1 and each second chain link (212, 412, 512) is separated from another adjacent second chain link by a second pitch P2, the first pitch P1 being approximately equal to the second pitch P2.

3. Transmission link (2) according to claim 1, characterised in that the first chain links (210, 210′, 410, 410′, 510, 510′, 700, 800, 900) are in contact with each other along the longitudinal direction (L), at least before interacting with the flanges (31, 32, 41, 42, 51, 52) of a wheel (3, 4, 5) of the transmission mechanism (1), the first set comprising mutual pushing means (213, 411, 506, 507, 903, 904).

4. Transmission link (2) according to claim 1, characterised in that each chain link comprising a receiving slot (2110, 2110′, 415, 515, 615, 621, 631, 641, 651) is capable of pivoting about a pivot axis (2114, 2114′, 420, 504, 633) approximately parallel to the axial direction (A) and passing inside the receiving slot of at least one contiguous chain link, said pivot axis being a nominal position of said receiving slot of the contiguous chain link, said nominal position being a position that the axis of the engagement rod (2120, 2120′, 2120″, 4103, 505, 600, 642, 632) may occupy.

5. Transmission link (2) according to claim 4, characterised in that the engagement rod (2120, 2120′, 2120″, 4103, 505, 600, 642, 632) has an axis approximately parallel to the axial direction (A) and coincident with the pivot axis (2125, 4106, 4106′, 518) of two successive chain links belonging to the set of chain links comprising said engagement rod.

6. Transmission link (2) according to claim 1, characterised in that each first chain link (210, 210′, 410, 410′, 510, 510′, 800) comprises at least one shape plate (2101, 2102, 2102′, 2102″, 4101, 4102, 5101, 5101′, 801) capable of being pushed on a shape plate of at least one other first contiguous chain link, one of said mutually-supported contiguous first chain links being called the reference first chain link, the other being called the mobile first chain link, said mobile first chain link being capable of pivoting about a pivot axis (2114, 2114′, 4106, 4106′, 504) of said reference first chain link along an approximately circular trajectory, the pivot axis of the mobile first chain link being separated from the pivot axis of the reference first chain link by a radius approximately equal to pitch P1.

7. Transmission link (2) according to claim 4 characterised in that the receiving slot (2110, 2110′, 515, 615, 621, 631, 641, 651) belongs to a receiving solid (5103, 5103′, 1003, 701, 620, 630, 640, 650) integral with one of the sets of chain links, said receiving solid being capable of pivoting at least about an axis parallel to the axial direction (A) and coincident with the nominal position of the receiving slot.

8. Transmission link (2) according to claim 7 characterised in that the receiving solid (5103, 5103′, 1003, 701, 620, 630, 640, 650) has at least one orientation means (214, 502, 1001, 1001′) capable of orienting the receiving slot (2110, 2110′, 515, 615, 621, 631, 641, 651).

9. Transmission link (2) according to claim 1, characterised in that the set of bearing surfaces (2106, 2107, 2108, 2109, 4104, 4105, 5102) of a first chain link (210, 210′, 410, 410′, 510, 510′, 700, 800, 900) in contact on each flange (31, 32, 41, 42, 51, 52) of a wheel (3, 4, 5) has a support barycentre and that said support barycentres of both sides of said first chain link are joined by a straight line passing inside the receiving slot (2110, 2110′, 415, 515, 615, 621, 631, 641, 651).

10. Transmission link (2) according to claim 1, characterised in that the receiving slot (2110, 2110′, 415, 515, 615, 621, 631, 651) has a general approximately triangular shape.

11. Transmission link (2) according to claim 4, characterised in that either of the sets of chain links comprises a temporary return means of the engagement rod (1003, 1003′) towards the nominal position of the receiving slot (1002).
